(19) United States
(12) Patent Application Publication
(10) Pub. No.: US 2022/0261841 A1
(43) Pub. Date: Aug. 18, 2022

(54) SYSTEMS AND METHODS FOR GENERATING INCENTIVE OFFER DATA OBJECTS

(71) Applicant: Eventlink, LLC, Sterling Heights, MI (US)

(72) Inventors: Hank Marquardt, Lombard, IL (US); Chris Lewis, Lombard, IL (US); Armando Bulnes, Lombard, IL (US); Danielle Butcher, Detroit, MI (US); David Genova, Detroit, MI (US); Dorothy Cioban, Detroit, MI (US); Ron Parkinson, Detroit, MI (US)

(21) Appl. No.: 17/668,633

(22) Filed: Feb. 10, 2022

Related U.S. Application Data
(60) Provisional application No. 63/148,904, filed on Feb. 12, 2021.

(51) Int. Cl. G06Q 30/02; G06F 40/58

(52) U.S. Cl. CPC G06Q 30/0239; G06F 40/58

(57) ABSTRACT

A method for generating and managing incentive offers includes receiving incentive offer input and generating, based on the incentive offer input, an incentive offer data object. The method also includes communicating the incentive offer data object to a first remote computing device corresponding to a first approving entity. The method also includes receiving, from the first remote computing device, a first approving entity message and, in response to a determination that the first approving entity message indicates that the first approving entity approved the incentive offer data object, communicating the incentive offer data object to a second remote computing device corresponding to a second approving entity. The method includes receiving, from the second remote computing device, a second approving entity message and, in response to a determination that the second approving entity message indicates that the second approving entity the incentive offer data object, storing the incentive offer data object.

### CROSS-REFERENCES TO RELATED APPLICATIONS

This patent application claims priority to U.S. Provisional Patent Application Ser. No. 63/148,904, filed Feb. 12, 2021 which is incorporated herein by reference in its entirety.

### TECHNICAL FIELD

This disclosure relates to product incentive offers, and in particular systems and methods for generating and managing incentive offer data objects.

### BACKGROUND

Goods manufacturers and service providers are increasingly relying on directed and/or targeting marketing to increase awareness and/or sales of various goods and/or services. Typically, this includes the use of incentive offers, such as discounts, specials, and the like, during certain periods or under certain conditions. Generating and managing such incentive offers may include a significant amount of manual intervention. As such, incentive offer generation and management may be relatively resource intensive and prone to human error.

### SUMMARY

This disclosure relates generally to digital messaging.

An aspect of the disclosed embodiments includes a method for generating and managing incentive offers. The method includes receiving, at a first user interface, incentive offer input and generating, based on the incentive offer input, an incentive offer data object. The method also includes communicating the incentive offer data object to a first remote computing device, the first remote computing device corresponding to a first approving entity, and being configured to provide a second user interface. The method also includes receiving, from the first remote computing device, a first approving entity message. The method also includes, in response to a determination that the first approving entity message indicates that the first approving entity approved the incentive offer data object, communicating the incentive offer data object to a second remote computing device, the second remote computing device corresponding to a second approving entity and being configured to provide a third user interface. The method also includes receiving, from the second remote computing device, a second approving entity message and, in response to a determination that the second approving entity message indicates that the second approving entity the incentive offer data object, storing the incentive offer data object.

Another aspect of the disclosed embodiments includes a system for generating and managing incentive offers. The system includes a processor and a memory. The memory includes instructions that, when executed by the processor, cause the processor to: receive, at a first user interface, incentive offer input; generate, based on the incentive offer input, an incentive offer data object; communicate the incentive offer data object to a first remote computing device, the first remote computing device corresponding to a first approving entity and being configured to provide a second user interface; receive, from the first remote computing device, a first approving entity message; in response to a determination that the first approving entity message indicates that the first approving entity approved the incentive offer data object, communicate the incentive offer data object to a second remote computing device, the second remote computing device corresponding to a second approving entity and being configured to provide a third user interface; receive, from the second remote computing device, a second approving entity message; and, in response to a determination that the second approving entity message indicates that the second approving entity the incentive offer data object, store the incentive offer data object.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a computing ecosystem according to the principles of the present disclosure.

FIG. 2 generally illustrates a computing device according to the principles of the present disclosure.

FIG. 3 is a flow diagram generally illustrating an incentive offer generation and management method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, goods manufacturers and service providers are increasingly relying on directed and/or targeting marketing to increase awareness and/or sales of various goods and/or services. Typically, this includes the use of incentive offers, such as discounts, specials, and the like, during certain periods or under certain conditions. Generating and managing such incentive offers may include a significant amount of manual intervention. As such, incentive offer generation and management may be relatively resource intensive and prone to human error.

Accordingly, systems and methods, such as those described herein, configured to provide a web-based platform that allows goods manufacturers and/or service providers to create, approve, and/or traffic market or retailer specific offers or incentives using one or more user interfaces, may be desirable. In some embodiments, the systems and methods described herein may be configured to allow an approving entity (e.g., such as a project manager) a single location to locate incentive offers as well as preapproved offers, which may provide reduced routing times and may decrease the number of revisions associated with an incentive offer data object.

The systems and methods described herein may be configured to reduce process duplication and reduce the number of information storage mechanisms (e.g., spreadsheets, and the like), while standardizing key business processes and consolidating communication channels. The systems and methods described herein may be configured to provide ad-hoc review processes (e.g., including legal review, project management review, and the like). The systems and methods described herein may be configured to access the incentive distribution using a password protected web platform.

In some embodiments, the systems and methods described herein may be configured to provide instantaneous or substantially instantaneous availability of an incentive offer data object via a web-based interface, upon approval of the incentive offer data object. The systems and methods described herein may be configured to provide third parties (e.g., vendors and the like) corresponding incentive offer data objects in response to approval of the incentive offer data object. Additionally, or alternatively, the systems and methods described herein may be configured to provide access for retrieval (e.g., via a download or other suitable retrieval technique) of approved incentive offer data objects (e.g., which may allow for incentive offer data objects to be pushed directly to corresponding online platforms or third parties using minimal user interaction).

In some embodiments, the systems and methods described herein may be configured to a user interface that includes various input fields. The various input fields may correspond to specific information used to generate a corresponding incentive offer data object. The systems and methods described herein may be configured to allow a user to access the user interface to create custom incentive offer data objects.

An incentive offer data object may correspond to an offer for a product and/or service. For example, an incentive offer data object may indicate a current offer for a particular vehicle make, model, trim level, and so on. It should be understood that, while the incentive offer data object is described in the context of a vehicle offer, any suitable product and/or service may be associated with a corresponding incentive offer data object. Additionally, or alternatively, the incentive offer data object may include any suitable data object format. For example, the incentive offer data object may include a hypertext markup language protocol data object, a Java data object, a portable document format data object, a word processing application data object, a text data object, other suitable data object, or a combination thereof.

In some embodiments, the systems and methods described herein may be configured to communicate, after the incentive offer data object is generated, the incentive offer data object another approving entity. The other approving entity may include a legal approving entity. The other approving entity may receive the incentive offer data object at a corresponding user interface, which may be remotely disposed from the user interface used to generate the incentive offer data object. The other approving entity may review the incentive offer data object against a set of legal standards, rules, and the like. The other approving entity may approve the incentive offer data object (e.g., if the incentive offer data object meets or exceeds the legal standards, rules, and the like) or reject the incentive data object (e.g., if the incentive data object does not meet the legal standards, rules, and the like).

In some embodiments, the systems and methods described herein may be configured to communicate, in response to the incentive offer data object being rejected, the incentive offer data object and/or at least one request for information message to the user interface used to generate the incentive offer data object. The request for information message may include any suitable message and/or message format. The request for information message may indicate a request for additional and/or different information to be appended or changed in the incentive offer data object to overcome the rejection of the incentive offer data object.

The systems and methods described herein may be configured to allow the user to revise or update the incentive offer data object using the user interface and/or a subsequent user interface. The systems and methods described herein may be configured to communicate, in response to the incentive offer data object being updated, the incentive offer data object to the other approving entity. The systems and methods described herein may be configured to, upon approval of the incentive offer data object by the other approving entity, create at least one report indicating all currently approved incentive offer data objects. The systems and methods described herein may be configured to provide approved incentive offer data objects to third parties (e.g., such as vendors, media providers, and the like) in real-time or near real-time.

It should be understood that, while the embodiments described herein include two approving entities, the systems and methods described herein may include fewer approving entities, additional approving entities, and/or different approving entities than those described herein.

In some embodiments, the systems and methods described herein may be configured to direct branded incentive offer data objects directly to online platforms. For example, the systems and methods described herein may be configured to use an application programming interface to retrieve incentive offer data objects for a particular brand of product and/or service associated with a specific goods manufacturer and/or service provider. The systems and methods described herein may be configured to provide, using the application programming interface, the corresponding incentive offer data objects to a respective online platform associated with the specific goods manufacturer and/or service provider.

In some embodiments, the systems and methods described herein may be configured to define unique rules and/or permissions for corresponding users. The systems and methods described herein may be configured to assign various users to corresponding rules and/or permissions, such that a user may be granted access to features of the systems and methods described herein based on the assigned rule and/or permissions.

In some embodiments, the systems and methods described herein may be configured to provide standard incentive offer data object features (e.g., such as legal brand language or other suitable features), which may allow for a more efficient approval of the incentive offer data object.

In some embodiments, the systems and methods described herein may be configured to provide sortable incentive offer data object reports. The reports may be sortable by region, market group, retailer group, other critical indicators or associated information, or a combination thereof.

In some embodiments, the systems and methods described herein may be configured to provide built-in platform communication (e.g., which may reduce or eliminate a need to generate independent messages, documents, spreadsheets, and the like). The systems and methods described herein may be configured to leverage an existing workforce by distributing accountability to subject matter experts. The systems and methods described herein may be configured to provide an integrated web-based application programming interface, which may allow for direct delivery and upload of approved advertisements to a respective online platform.

In some embodiments, the systems and methods described herein may be configured to reduce or eliminate spreadsheets and process duplication associated with generating and using incentive offer data objects. The systems and methods described herein may be configured to provide a copy and/or clone feature, which may allow users to select existing, applicable offer information when generating an incentive offer data object.

In some embodiments, the systems and methods described herein may be configured to provide incentive offer data object templates. An incentive offer data object template may define the input requirements and constraints for a respective incentive offer data object, which may populate the user interface used to generate the incentive offer data object with specific information associate with the respective incentive offer data object (e.g., with respect to an automotive incentive offer data object, the information may correspond to a lease offer, a cash back offer, a special (e.g., such as Labor Day, year end, and the like), other suitable information, or a combination thereof).

In some embodiments, the systems and methods described herein may be configured to a project manager with functionality to assign and/or publish specific incentives offer data objects to distinct organizing units (e.g., such as geographies, local marketing associates (LMAs), regional groups, national groups, and the like). The systems and methods described herein may be configured to provide incentive offer data objects to specific publication channels (e.g. print media, audio media, visual media, digital media, application programming interfaces, third parties, and the like). The systems and methods described herein may be configured to provide, for each respective publication channel, a corresponding format for the incentive offer data objects to conform to constraints set by the respective publication channels. The systems and methods described herein may be configured to provide the incentive offer data objects in any suitable format, such as a spreadsheet, an application programming interface pull, and the like.

In some embodiments, the systems and methods described herein may be configured to provide a publisher at least some publication channels with filter options when navigating content from a storage associated with the application programming interface. Approved incentive offer data objects accessible via the application programming interface may be filtered based on, but not limited to, retailer, brand, product, service, and geographic location. The systems and methods described herein may be configured to transmit selected incentive offer data objects to a publisher and/or a publication channel in response to receiving a request for the incentive offer data object.

In some embodiments, the systems and methods described herein may be configured to receive, at a first user interface, incentive offer input. The systems and methods described herein may be configured to generate, based on the incentive offer input, an incentive offer data object. The systems and methods described herein may be configured to communicate the incentive offer data object to a first remote computing device. The first remote computing device may correspond to a first approving entity and may be configured to provide a second user interface.

The systems and methods described herein may be configured to receive, from the first remote computing device, a first approving entity message. The systems and methods described herein may be configured to, in response to a determination that the first approving entity message indicates that the first approving entity approved the incentive offer data object, communicate the incentive offer data object to a second remote computing device. The second remote computing device may correspond to a second approving entity and may be configured to provide a third user interface. Alternatively, the systems and methods described herein may be configured to, in response to a determination that the first approving entity message indicates that the first approving entity did not approve the incentive offer data object, generate a request for subsequent input. The systems and methods described herein may be configured to provide, at the first user interface, the request for subsequent input.

The systems and methods described herein may be configured to receive, from the second remote computing device, a second approving entity message. The systems and methods described herein may be configured to, in response to a determination that the second approving entity message indicates that the second approving entity the incentive offer data object, store the incentive offer data object. Alternatively, the systems and methods described herein may be configured to, in response to a determination that the second approving entity message indicates that the second approving entity did not approve the incentive offer data object, generate a request for subsequent input. The systems and methods described herein may be configured to provide, at the first user interface, the request for subsequent input. In some embodiments, the incentive offer data object corresponds to a product offer. In some embodiments, the incentive offer data object corresponds to a service offer. In some embodiments, the first approving entity includes a project management approving entity. In some embodiments, the second approving entity includes a legal approving entity.

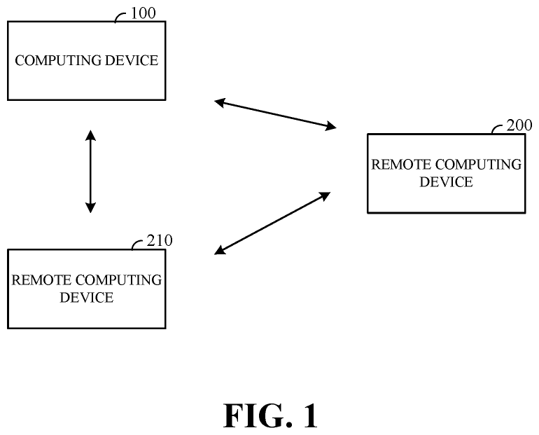

FIG. 1 generally illustrates a computing ecosystem according to the principles of the present disclosure. The ecosystem may include a computing device 100. The computing device 100 may be configured to provide a first user interface. The first user interface may be configured to allow a user to provide input corresponding to an incentive offer, revise or add input associated with an incentive offer, selective incentive offer template, select incentive offer features, select incentive offer data objects, provide other suitable features, or a combination thereof. The computing device 100 may include any suitable computing device, such as a mobile computing device, a laptop computing device, a desktop computing device, a server-computing device, or any other suitable computing device.

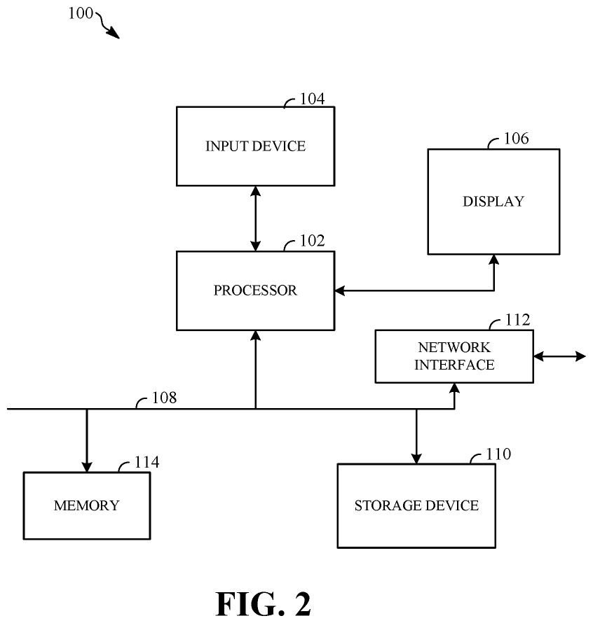

As is generally illustrated in FIG. 2 the computing device 100 may include a processor 102 configured to control the overall operation of computing device 100. The processor 102 may include any suitable processor, such as those described herein. Additionally, or alternatively, the computing device 100 may include one or more processors in addition to or instead of the processor 102. The computing device 100 may also include a user input device 104 that is configured to receive input from a user of the computing device 100 and to communicate signals representing the input received from the user to the processor 102. For example, the user input device 104 may include a button, keypad, dial, touch screen, audio input interface, visual/image capture input interface, input in the form of sensor data, etc.

The computing device 100 may include a display 106 that may be controlled by the processor 102 to display information to the user. A data bus 108 may be configured to facilitate data transfer between, at least, a storage device 110 and the processor 102. The computing device 100 may also include a network interface 112 configured to couple or connect the computing device 100 to various other computing devices or network devices via a network connection, such as a wired or wireless connection. In some embodiments, the network interface 112 includes a wireless transceiver.

The storage device 110 may comprise a single disk or a plurality of disks (e.g., hard drives), one or more solid-state drives, one or more hybrid hard drives, and the like. The storage device 110 may include a storage management module that manages one or more partitions within the storage device 110. In some embodiments, storage device 110 may include flash memory, semiconductor (solid state) memory, or the like. The computing device 100 may also include a memory 114. The memory 114 may include Random Access Memory (RAM), a Read-Only Memory (ROM), or a combination thereof. The memory 114 may store programs, utilities, or processes to be executed in by the processor 102. The memory 114 may provide volatile data storage, and stores instructions related to the operation of the computing device 100.

In some embodiments, the processor 102 may be configured to execute instructions stored on the memory 114 to, at least, generate and manage incentive offer data objects and/or any other features described herein.

The ecosystem may also include a first remote computing device 200 and a second remote computing device 210. The first remote computing device 200 and the second remote computing device 210 may include any suitable computing devices and may include features similar to and/or different from the computing device 100. The first remote computing device 200 may be located remotely from the computing device 100 and/or the second remote computing device 210. Additionally, or alternatively, the second remote computing device 210 may be located remotely from the computing device 100 and/or the first remote computing device 200.

The computing device 100, the first remote computing device 200, and/or the second remote computing device 210 may communicate using any suitable communications protocol and/or communications network.

In some embodiments, the computing device 100 may receive, at the first user interface, incentive offer input. The incentive offer input may include information corresponding to a respective incentive offer. The incentive offer input may include information provided by the user using one or more input fields (e.g., drop down fields, free form text fields, and the like), information selected by the user from one or more predefined features, template information, and the like. Such input fields may include, but are not limited to, offer information: offer start date information, offer end date information, vehicle model year information, vehicle model information, vehicle trim information, offer type information, offer region(s), offer target group(s), offer retail event information, offer restriction information, additional offer detail information, other suitable information, or a combination thereof.

The computing device 100 may generate, based on the incentive offer input, an incentive offer data object. The computing device 100 may communicate the incentive offer data object to the first remote computing device 200. The first remote computing device 200 may be configured to provide a second user interface. Additionally, or alternatively, the first remote computing device 200 may correspond to a first approving entity, such as a project manager or other suitable approving entity. In some embodiments, the first approving entity may correspond to an individual or group of individuals. In some embodiments, the first approving entity may correspond to an artificial intelligence configured to use at least one machine learning model configured (e.g., trained using training data) to perform functions of the first approving entity. The first approving entity may compare aspects of the incentive offer data object to a first set of standards or rules. The first approving entity may approve the incentive offer data object (e.g., if the incentive offer data object meets or exceeds the first set of standards or rules) or reject the incentive offer data object (e.g., if the incentive offer data object does not meet the first set of standards or rules).

The first approving entity may interact with the second user interface to generate a first approving entity message. The first approving entity message may indicate whether the first approving entity approved or rejected the incentive offer data object. Additionally, or alternatively, the first approving entity message may indicate a request for subsequent information. The request for subsequent information may indicate one or more requests to revise the incentive offer data object (e.g., to overcome a rejection of the incentive offer data object).

The computing device 100 may receive, from the first remote computing device 200, the first approving entity message. The computing device 100 may determine whether the first approving entity message indicates that the first approving entity approved the incentive offer data object. The computing device 100, in response to a determination that the first approving entity message indicates that the first approving entity approved the incentive offer data object, may communicate the incentive offer data object to the second remote computing device 210.

Alternatively, the computing device 100 may, in response to a determination that the first approving entity message indicates that the first approving entity did not approve the incentive offer data object, generate a request for subsequent input. For example, the computing device 100 may generate a request for subsequent input based on the request for subsequent information indicated by the first approving entity message. The computing device 100 may provide, at the first user interface, the request for subsequent input. The user may interact with the first user interface to provide the subsequent input. The computing device 100 may revise or update the incentive offer data object based on the subsequent input. The computing device 100 may communicate the updated incentive offer data object to the first remote computing device 200 for review, at the second user interface, by the first approving entity.

The second remote computing device 210 may be configured to provide a third user interface. Additionally, or alternatively, the second remote computing device 210 may correspond to a second approving entity, such as a member of a legal department or other suitable approving entity. In some embodiments, the second approving entity may correspond to an individual or group of individuals. In some embodiments, the second approving entity may correspond to an artificial intelligence configured to use at least one machine learning model configured (e.g., trained using training data) to perform functions of the second approving entity. The second approving entity may compare aspects of the incentive offer data object to a second set of standards or rules. The second approving entity may approve the incentive offer data object (e.g., if the incentive offer data object meets or exceeds the second set of standards or rules) or reject the incentive offer data object (e.g., if the incentive offer data object dos not meet the second set of standards or rules).

The second approving entity may interact with the third user interface to generate a second approving entity message. The second approving entity message may indicate whether the second approving entity approved or rejected the incentive offer data object. Additionally, or alternatively, the second approving entity message may indicate a request for subsequent information. The request for subsequent information may indicate one or more requests to revise the incentive offer data object (e.g., to overcome a rejection of the incentive offer data object).

The computing device 100 may receive, from the second remote computing device 210, the second approving entity message. The computing device 100 may determine whether the second approving entity message indicates that the second approving entity approved the incentive offer data object. The computing device 100 may, in response to a determination that the second approving entity message indicates that the second approving entity the incentive offer data object, store the incentive offer data object. For example, computing device 100 may store the incentive offer data object in a database, a memory, a storage system, or other suitable location. The computing device 100 may store the incentive offer data object remove from the computing device 100. The incentive offer data object may be stored with other approved incentive data objects. As described, third parties and/or application programming interfaces may retrieve the incentive offer data object and/or other incentive offer data objects. The third parties and/or application programming interfaces may proceed as described.

Alternatively, computing device 100 may, in response to a determination that the second approving entity message indicates that the second approving entity did not approve the incentive offer data object, generate a request for subsequent input. For example, the computing device 100 may generate a request for subsequent input based on the request for subsequent information indicated by the second approving entity message. The computing device 100 may provide, at the first user interface, the request for subsequent input. The user may interact with the first user interface to provide the subsequent input. The computing device 100 may revise or update the incentive offer data object based on the subsequent input. The computing device 100 may communicate the updated incentive offer data object to the first remote computing device 200 for review, at the second user interface, by the first approving entity. The computing device 100 may proceed as described.

In some embodiments, the first remote computing device 200 may receive the second approving entity message from the second remote computing device 210 indicating whether the second approving entity approved the incentive offer data object.

In some embodiments, the computing device 100 may perform the methods described herein. However, the methods described herein as performed by the computing device 100 are not meant to be limiting, and any type of software executed on a controller can perform the methods described herein without departing from the scope of this disclosure. For example, a controller, such as a processor executing software within a computing device, can perform the methods described herein.

In some embodiments, the processor 102 may restrict access/editing privileges based on a hierarchical user access regime. The processor 102 may store account categories that may include, an administrator account category, a manager account category, a legal account category, a staff account category, and any other suitable account category. The computing device 100 may, responsive to input from a user of the computing device 100, set a respective account category for each user, which may allow for control of access and/or editing permissions to various functions (e.g., based on one or more permissions associated with a respective account category).

In some embodiments, account permissions or settings may be adjustable based on the responsibilities of the account category. For example, a user having a legal account category is allowed granted access to the active incentive offers and is further granted access to editing input fields related to legal considerations of the incentive offer.

In some embodiments, the processor 102 may automatically generate fine print information for an incentive offer based on information obtained from the legal input fields. The processor 102 may receive legal information associated with an incentive offer from an input field (e.g., that receives information from a user entering legal-related information into the input field). The legal information may already be associated with the incentive offer data object template that created the incentive offer. The legal information may include, information related to legal restrictions of a geographical region, and legal information related to regulatory restrictions related to the product. The processor 102 may automatically generate the fine print based on the publishing requirements of the publisher and/or publication channel. The processor 102 may insert the fine print into the incentive offer data object and making it available to publishers and/or publishing channels via the application programming interface.

In some embodiments, the processor 102 may create new incentive offer data object templates, responsive to input from a user, and store the new incentive offer data object template (e.g., such as in a database, a memory, a storage system, or other suitable location). The processor 102 may associate an incentive offer data object with the incentive offer data object template. The incentive offer data object template may include an offer start date information, offer end date information, vehicle model year information, vehicle model information, vehicle trim information, offer type information, offer region(s), offer target group(s), offer retail event information, offer restriction information, additional offer detail information, other suitable information, or a combination thereof. The processor 102 may filter search results based on the input fields associated with the incentive offer data object template.

In some embodiments, the processor 102 may generate a unique identification number for an incentive offer data object in response to receiving approval of the incentive offer data object (e.g., from all required approving entities). The processor 102 may store an approved incentive offer data object with a record of its unique identification number, approval information (e.g., including approval time information, approving entity information, and the like), and/or the account categories of the users who approved the incentive offer data object.

In some embodiments, the processor 102 may generate alternative language versions of the incentive offer data object. The processor 102 may automatically add alternate language versions of the incentive offer data object based on the geographical location associated with the incentive offer data object. For example, the processor 102 may detect a geographical location associated with the incentive offer data object and may determine a one or more languages (e.g., Spanish, French, Portuguese, and the like) associated with the geographical location. The processor 102 may generate the alternative language versions of the incentive offer data object based on the one or more languages.

In some embodiments, the incentive offer data object may further include additional offers associated with the incentive offer data object. The processor 102 may use additional conditions that are required before the user qualifies for the additional incentives. For example, an employee of the company may qualify for the incentive in the incentive offer data object, but may also be eligible for an additional incentive based on his status as an employee. A single incentive offer data object may include both of the offers and the additional conditions required to qualify for the additional incentives.

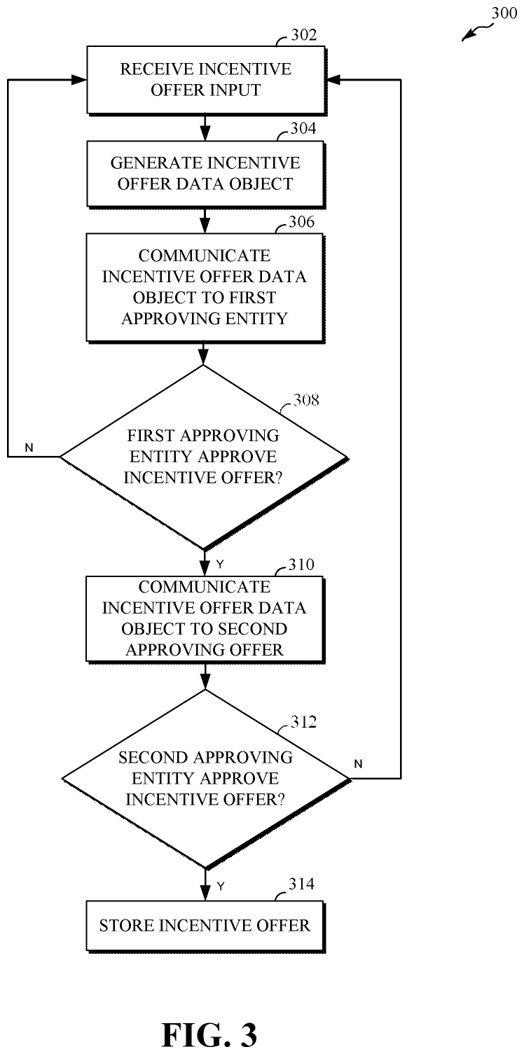

FIG. 3 is a flow diagram generally illustrating an incentive offer generation and management method 300 according to the principles of the present disclosure. At 302, the method 300 receives incentive offer input. For example, the processor 102 may receive the incentive offer input at the first user interface.

At 304, the method 300 generates, based on the incentive offer input, an incentive offer data object. For example, the processor 102 may generate, based on the incentive offer input, the incentive offer data object.

At 306, the method 300 communicates the incentive offer data object to a first remote computing device, the first remote computing device corresponding to a first approving entity and being configured to provide a second user interface. For example, the processor 102 communicates the incentive offer data object to the first remote computing device 200.

At 308, the method 300 determines whether the first approving entity approved the incentive offer data object. For example, the processor 102 may receive, from the first remote computing device 200, the first approving entity message. The processor 102 may determine whether the first approving entity message indicates that the first approving entity approved the incentive offer data object. If the processor 102 determines that the first approving entity approved the incentive offer data object, the method 300 continues at 310. Alternatively, if the processor 102 determines that the first approving entity did not approve the incentive offer data object, the method 300 continues at 302.

At 310, the method 300 communicates the incentive offer data object to a second remote computing device, the second remote computing device corresponding to a second approving entity and being configured to provide a third user interface. For example, the computing device 100 communicates the incentive offer data object to the second remote computing device 210.

At 312, the method 300 determines whether the second approving entity approved the incentive offer data object. For example, the processor 102 may receive, from the second remote computing device 210, the second approving entity message. The processor 102 may determine whether the second approving entity message indicates that the second approving entity approved the incentive offer data object. If the processor 102 determines that the second approving entity approved the incentive offer data object, the method 300 continues at 314. Alternatively, if the processor 102 determines that the second approving entity did not approve the incentive offer data object, the method 300 continues at 302.

At 314, the method 300 stores the incentive offer data object. For example, the processor 102 may store the incentive offer data object.

In some embodiments, a method for generating and managing incentive offers includes receiving, at a first user interface, incentive offer input and generating, based on the incentive offer input, an incentive offer data object. The method also includes communicating the incentive offer data object to a first remote computing device, the first remote computing device corresponding to a first approving entity and being configured to provide a second user interface. The method also includes receiving, from the first remote computing device, a first approving entity message. The method also includes, in response to a determination that the first approving entity message indicates that the first approving entity approved the incentive offer data object, communicating the incentive offer data object to a second remote computing device, the second remote computing device corresponding to a second approving entity and being configured to provide a third user interface. The method also includes receiving, from the second remote computing device, a second approving entity message and, in response to a determination that the second approving entity message indicates that the second approving entity the incentive offer data object, storing the incentive offer data object.

In some embodiments, the method also includes, in response to a determination that the first approving entity message indicates that the first approving entity did not approve the incentive offer data object, generating a request for subsequent input. In some embodiments, the method also includes providing, at the first user interface, the request for subsequent input. In some embodiments, the method also includes, in response to a determination that the second approving entity message indicates that the second approving entity did not approve the incentive offer data object, generating a request for subsequent input. In some embodiments, the method also includes providing, at the first user interface, the request for subsequent input. In some embodiments, the incentive offer data object corresponds to a product offer. In some embodiments, the incentive offer data object corresponds to a service offer. In some embodiments, the first approving entity includes a project management approving entity. In some embodiments, the second approving entity includes a legal approving entity.

In some embodiments, a system for generating and managing incentive offers includes a processor and a memory. The memory includes instructions that, when executed by the processor, cause the processor to: receive, at a first user interface, incentive offer input; generate, based on the incentive offer input, an incentive offer data object; communicate the incentive offer data object to a first remote computing device, the first remote computing device corresponding to a first approving entity and being configured to provide a second user interface; receive, from the first remote computing device, a first approving entity message; in response to a determination that the first approving entity message indicates that the first approving entity approved the incentive offer data object, communicate the incentive offer data object to a second remote computing device, the second remote computing device corresponding to a second approving entity and being configured to provide a third user interface; receive, from the second remote computing device, a second approving entity message; and, in response to a determination that the second approving entity message indicates that the second approving entity the incentive offer data object, store the incentive offer data object.

In some embodiments, the instructions further cause the processor to, in response to a determination that the first approving entity message indicates that the first approving entity did not approve the incentive offer data object, generating a request for subsequent input. In some embodiments, the instructions further cause the processor to provide, at the first user interface, the request for subsequent input. In some embodiments, the instructions further cause the processor to, in response to a determination that the second approving entity message indicates that the second approving entity did not approve the incentive offer data object, generate a request for subsequent input. In some embodiments, the instructions further cause the processor to provide, at the first user interface, the request for subsequent input. In some embodiments, the incentive offer data object corresponds to a product offer. In some embodiments, the incentive offer data object corresponds to a service offer. In some embodiments, the first approving entity includes a project management approving entity. In some embodiments, the second approving entity includes a legal approving entity.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method for generating and managing incentive offers, the method comprising:
receiving, at a first user interface, incentive offer input;
generating, based on the incentive offer input, an incentive offer data object;
communicating the incentive offer data object to a first remote computing device, the first remote computing device corresponding to a first approving entity and being configured to provide a second user interface;
receiving, from the first remote computing device, a first approving entity message;
in response to a determination that the first approving entity message indicates that the first approving entity approved the incentive offer data object, communicating the incentive offer data object to a second remote computing device, the second remote computing device corresponding to a second approving entity and being configured to provide a third user interface;
receiving, from the second remote computing device, a second approving entity message; and
in response to a determination that the second approving entity message indicates that the second approving entity approved the incentive offer data object, storing the incentive offer data object.

2. The method of claim 1, further comprising, in response to a determination that the first approving entity message indicates that the first approving entity did not approve the incentive offer data object, generating a request for subsequent input.

3. The method of claim 2, further comprising providing, at the first user interface, the request for subsequent input.

4. The method of claim 1, further comprising, in response to a determination that the second approving entity message indicates that the second approving entity did not approve the incentive offer data object, generating a request for subsequent input.

5. The method of claim 4, further comprising providing, at the first user interface, the request for subsequent input.

6. The method of claim 1, wherein the incentive offer data object corresponds to a product offer.

7. The method of claim 1, wherein the incentive offer data object corresponds to a service offer.

8. The method of claim 1, wherein the first approving entity includes a project management approving entity.

9. The method of claim 1, wherein the second approving entity includes a legal approving entity.

10. A system for generating and managing incentive offers, the system comprising:
a processor; and
a memory including instructions that, when executed by the processor, cause the processor to:
receive, at a first user interface, incentive offer input;
generate, based on the incentive offer input, an incentive offer data object;
communicate the incentive offer data object to a first remote computing device, the first remote computing device corresponding to a first approving entity and being configured to provide a second user interface;
receive, from the first remote computing device, a first approving entity message;
in response to a determination that the first approving entity message indicates that the first approving entity approved the incentive offer data object, communicate the incentive offer data object to a second remote computing device, the second remote computing device corresponding to a second approving entity and being configured to provide a third user interface;
receive, from the second remote computing device, a second approving entity message; and
in response to a determination that the second approving entity message indicates that the second approving entity approved the incentive offer data object, store the incentive offer data object.

11. The system of claim 10, wherein the instructions further cause the processor to, in response to a determination that the first approving entity message indicates that the first approving entity did not approve the incentive offer data object, generating a request for subsequent input.

12. The system of claim 11, wherein the instructions further cause the processor to provide, at the first user interface, the request for subsequent input.

13. The system of claim 10, wherein the instructions further cause the processor to, in response to a determination that the second approving entity message indicates that the second approving entity did not approve the incentive offer data object, generate a request for subsequent input.

14. The system of claim 13, wherein the instructions further cause the processor to provide, at the first user interface, the request for subsequent input.

15. The system of claim 10, wherein the incentive offer data object corresponds to a product offer.

16. The system of claim 10, wherein the incentive offer data object corresponds to a service offer.

17. The system of claim 10, wherein the first approving entity includes a project management approving entity.

18. The system of claim 10, wherein the second approving entity includes a legal approving entity.

19. An apparatus for generating incentive offers, the apparatus comprising:
a processor; and
a memory including instructions that, when executed by the processor, cause the processor to:
receive, at a first user interface, incentive offer input;
generate, based on the incentive offer input, an incentive offer data object;
communicate the incentive offer data object to a first remote computing device, the first remote computing device corresponding to a first approving entity and being configured to provide a second user interface;
receive, from the first remote computing device, a first approving entity message;
in response to a determination that the first approving entity message indicates that the first approving entity approved the incentive offer data object, communicate the incentive offer data object to a second remote computing device, the second remote computing device corresponding to a second approving entity and being configured to provide a third user interface;
receive, from the second remote computing device, a second approving entity message;
in response to a determination that the second approving entity message indicates that the second approving entity approves the incentive offer data object, communicate the incentive offer data object, and the second approving entity message to the first user interface;
in response to a determination that the second approving entity message indicates that the second approving entity approved the incentive offer data object, make available the incentive offer data object via an application programming interface that is accessible to one or more publishing channels, the incentive offer data object having a format corresponding to an expected format associated with a publication channel of the one or more publication channels, the expected format conforming the incentive offer data object to constraints received from the publication channel.

20. The apparatus of claim 19, wherein the system automatically generates an alternate language version of the incentive offer data object based on a geographic location being associated with the incentive offer data object.
